(19) United States
(12) Patent Application Publication
(10) Pub. No.: US 2019/0084343 A1
(43) Pub. Date: Mar. 21, 2019

(54) RECONFIGURABLE APPARATUS AND SYSTEM FOR MARKING AND DISPLAYING OF ITEMS

(71) Applicant: COMSERO, INC., Denver, CO (US)

(72) Inventor: Anthony Franco, Broomfield, CO (US)

(73) Assignee: COMSERO, INC., Denver, CO (US)

(21) Appl. No.: 16/138,713

(22) Filed: Sep. 21, 2018

Related U.S. Application Data
(60) Provisional application No. 62/561,570, filed on Sep. 21, 2017.
(60) Provisional application No. 62/561,550, filed on Sep. 21, 2017.

(51) Int. Cl. B43L 1/00; B43L 1/04

(52) U.S. Cl. CPC B43L 1/008; B43L 1/045

(57) ABSTRACT

The preferred embodiment of the invention comprises a stackable and modularly reconfigurable apparatus and system that provides a substrate for marking and displaying items. More specifically, embodiments of the present invention relate to a modularly reconfigurable apparatus and system featuring erasable writing surfaces with interconnection features.

### CROSS REFERENCE TO RELATED APPLICATIONS

This application claims the benefit of U.S. Provisional Patent Application 62/561,550, filed on Sep. 21, 2017, which is hereby incorporated by reference in its entirety. This application claims the benefit of U.S. Provisional Patent Application 62/561,570, filed on Sep. 21, 2017, which is hereby incorporated by reference in its entirety. This application claims the benefit of U.S. application Ser. No. 14/444,663, filed on Jul. 28, 2014, now U.S. Pat. No. 9,809,049 issued Nov. 7, 2017, which claims priority to U.S. Provisional Patent Application 61/886,768, filed on Oct. 4 2013.

### FIELD OF THE INVENTION

The present invention relates to a stackable and modularly reconfigurable apparatus and system that provides a substrate for marking and displaying items. More specifically, the present invention relates to a modularly reconfigurable apparatus and system featuring erasable writing surfaces with interconnection features.

### BACKGROUND OF THE INVENTION

Dry erase boards provide a surface for erasable writing surface to leave little or no visible residue when erased. Dry erase boards have become a widely accepted tool of written and graphic communication, or written content, for entities such as corporations, teaching institutions, and creative groups. Technologies enabling the erasable writing surface of dry erase boards are known to persons of ordinary skill in the art. A dry erase board typically comprises a board or substrate having a surface treated with an enamel, film, ultraviolet cured liquid, liquid varnish, or porcelain finish. The substrate is affixed to a structure allowing individuals to write on it with specially designed markers. While the ink of the marker dries on the substrate, the ink does not bond to the substrate surface and the writing can be easily removed with a soft eraser, cloth, finger, etc.

The rapid drying nature of the ink of the specially designed markers provides users with a rapidly editable product which has become widely accepted for collaborative and brain storming sessions as well as other scenarios which may benefit from such characteristics.

Yet traditional dry erase boards are limited to having fixation to a structure generally movable only with the use of tools and cannot be replaced elsewhere without certain hanging accessories or tools.

Traditional dry erase boards fail to provide a suitable option to preserve written content beyond the photographing of the board prior to the erasing of the written content. Traditional dry erase boards do not allow for the removal and/or replacement of a portion of a board displaying content. Sometimes traditional white boards are erased, potentially losing the benefit of content visibility. In other scenarios, a dry erase board may contain content deemed valuable to keep visible in a group setting and is not erased, thereby limiting usable area of the dry erase board.

Previously known storage and display units include tracks in order to store the erasable boards. However, inserting and removing the boards from the units can be difficult because each board must fit into a narrow track in order to properly hold the board. Additionally, the removable boards in such storage and display units can only be used when tracks are present. Thus, in such examples, the erasable boards are not transportable to locations without the tracks. Further, such examples are generally cumbersome to use and expensive.

Other examples of display options either results in the obscuring of written content or occupying floor space, limiting the number of display boards that may be used at one time. Still other examples, such as that described by U.S. Pat. No. 7,604,481 issued to Owen et al. on Oct. 20, 2009; (as referred to herein, “Owen”), fail to provide a system that permits the display of a white board system in lateral configurations without additional hanging systems. Furthermore, the frame required by Owen results in white board area that cannot be used for written content and prevents the formation of a series of contiguous writing surfaces.

Some collaborative and brain storming activities, sometimes referred to as ideation, still use separate technologies enabling such activities. Certain activities may benefit from the use of paper adhered to a wall, while others prefer the use of drawing and sketching on pre-printed materials. As such, there is an identified need to provide increased functionality, particularly with regard to removability and reconfigurability, over traditional dry erase boards.

### SUMMARY OF THE INVENTION

This invention relates to a system, device, and method for providing tablets with interconnection and/or mounting features. Certain embodiments of the present invention relate to a system of multiple tablets and a system for displaying the multiple tablets. It is an aspect of certain embodiments of the present invention to provide increased functionality over traditional dry erase boards.

Certain embodiments of the present invention relate to an erasable writing tablet system that provides for the easy interconnection of tablets, the quick rearrangement of the tablets without the use of slots or tracks, the easy interchangeability of writing surfaces and designs thereon, and mounting to a surface which may be used as a traditional dry erase surface.

In certain embodiments, features of the present invention may be employed in a wide range of uses, including the presentation of analog and digital material. Although the invention generally relates to tablets, such as dry erase boards with interconnection features, the invention and features described herein could easily be implemented in conjunction with chalk boards, mobile electronic devices, picture frames, clocks, artwork, signs, and other presentation media. The term “tablet” is used interchangeably with the term “board” herein.

It is another aspect of embodiments to provide a tablet with a frame and a tray (i.e., cover, top portion, upper portion, or overmold) that are easily interconnected and detachable from one another such that various trays can be used, or various inserts can be inserted between the tray and frame. Embodiments of the invention incorporate one or more subsets of the disclosures of U.S. Pat. No. 9,809,049, issued on Nov. 7, 2017, which is hereby incorporated by reference in its entirety.

It is an aspect of certain embodiments of the present invention to provide a system of tablets, such as erasable writing tablets, which may be removably interconnected with, and rearranged with respect to one another. In certain embodiments of the invention, a user may write on one board, write on one or more other boards, and then interconnect the two or more boards together using the boards' interconnection means. The interconnection means may be magnets, hooks, hook and loop material, straps, clips, buckles, hinges (such as a barrel hinge, living hinge, single continuous hinge, or plano hinge), female and male locking catches, or any interconnection mechanism known in the art. Further, the tablets may be assembled in any configuration on a substantially vertical plane (e.g., wall surface) or a substantially horizontal plane (e.g., table surface).

It is an aspect of certain embodiments of the present invention to provide a tablet which may be modified to result in various configurations to provide a user with multiple functionalities provided by elements such as a dry erase surface, a magnetically attractable surface, a chalk board surface and/or a brick connection surface.

It is an aspect of certain embodiments of the present invention to provide a transparent or translucent erasable writing surface which provides the ability for a user to dispose previously created content behind the erasable writing surface allowing a user to provisionally modify the content without permanent markings.

It is another aspect of certain embodiments of the present invention to provide a system of tablets that can be interconnected to one another in a variety of configurations. Such configurations include back-to-back, front-to-back, stagger-stacked and side-by-side. It will be appreciated that a stagger-stack of tablets surrounds a first tablet overlapping a portion of a second tablet, thus exposing surfaces of both the first tablet and the second tablet. The tablets of the system of the present invention may be used on either a substantially horizontal surface or a substantially vertical surface. A further aspect includes providing a system of tablets and mounting mechanisms that allow multiple tablets to be interconnected to a surface such that one tablet can be removed from the wall and/or moved to a new position on the wall without disturbing the other tablets. Thus, if the system includes nine tablets in a square array, the center tablet may be removed and reattached without disturbing the other eight tablets.

An aspect of certain embodiments of the present invention is to provide a tablet system that allows a user to easily reconfigure the tablets as desired. Thus, if one or more tablets of a tablet system makes more sense in a different location, then the user may easily move one or more tablets to a different location relative to the other tablets. Furthermore, if one or more tablets contain shared content, a user may reconfigure the tablets to stack the tablets containing shared content to conserve display area. Furthermore, the stacking of tablets having shared content in certain scenarios may be used to communicate a solution or thought pertaining to a particular topic having popular support.

An aspect of certain embodiments of the present invention is to promote collaboration within groups by allowing individuals to collaborative content. Thus, each person may write or draw his/her content on an individual tablet. Subsequently, a certain embodiment of the invention allows a user to combine and arrange any subset or all of the tablets to form a collaborated thought or picture.

It is another aspect of a certain embodiment of the present invention to provide a system of tablets that easily mount to a surface such that may be interconnected to one another on the surface. Thus, the tablets may be positioned on a wall or taken off of the wall individually to allow a user to write on one or more of the tablets. Additionally, the tablets may be rearranged on the wall with respect to one another.

In another aspect of certain embodiments of the present invention, a system of erasable writing tablets is provided where the writing tablets are removably affixed to a surface.

It is an aspect of certain embodiments of the present invention to provide tablets that, when interconnected, are properly aligned. Thus, the interconnection means provided on the tablets allow for accurate alignment of the tablets.

It is another aspect of certain embodiments the present invention to provide increased reconfigurability with single-handed use.

It is an additional aspect of certain embodiments of the present invention to provide a magnetically attractable surface for the removable fixation of tablets.

It is an aspect of certain embodiments of the present invention to allow the removable fixation of a tablet, to a magnetically attractable surface without constraining the user to a particular placement or configuration of the tablet or tablets.

It is an aspect of certain embodiments of the present invention to allow the removable fixation of a tablet to a surface while preventing the tablet from marring the surface when the tablet is affixed to or slid upon the surface.

Certain embodiments of the present invention comprise a tablet constructed of a first panel and a second panel, each having a planar form. The first panel and second panel are interconnected and offset from each other. Each of the first and second panel have apertures that align. Inserts are disposed through and mated through the aligned apertures of the first panel and the second panel. The mating of the inserts with the apertures of the first panel and second panel constrains the panels parallel to and offset from each other.

The tablets of certain embodiments have a regular polygonal form. Tablets of some regular polygonal forms, such as squares and triangles, allow for the tight configuration or nesting of tablets with minimal space in between the nested tablets. It will be appreciated by a person of ordinary skill in the art that a regular polygon surrounds a polygonal form which is equiangular and equilateral. It may be desired in certain embodiments for a panel to have a notch or multiple notches. A notch, particularly surrounding tablets configured to nest in a tight configuration when removably affixed to a substrate, provide openings between nested tablets. Furthermore, when a first notch of a first tablet is adjacent to a first notch of a second tablet, this provides a larger opening between nested tablets. In certain embodiments, a notch results in a truncated corner of a panel or tablet. Openings between tablets allows a user to dispose their finger within the opening to pull on the panel in order to disengage the tablet from the substrate to which it is removably affixed.

Certain embodiments of the present invention incorporate a first panel and a second panel interconnected together via magnetic inserts composed of a sleeve with a magnet placed within. The sleeve in certain embodiments, has a length greater than the length of the magnet placed within. In certain embodiments, the magnet placed within the sleeve is recessed from both ends of the sleeve. When a magnetic insert comes in contact with a substrate, the sleeve of the insert contacts the surface, but the magnet does not contact the substrate.

The sleeve of certain embodiments is composed of a polymer for mating with certain surfaces, such as a dry erase surface, without marring the surface when placed upon or slid upon the surface.

In certain embodiments, an insert extends beyond an outward facing surface of the first panel and extends beyond an outward facing surface of the second panel. Thus, upon placement of the tablet on a substrate with the first panel adjacent to the substrate, the first panel does not contact the substrate. Similarly, upon placement of the tablet on a substrate with the second panel adjacent to the substrate, the second panel does not contact the substrate. Furthermore, upon arrangement of a first tablet and a second tablet in a stacked or stagger-stacked configuration, a first panel of the first tablet does not contact an adjacent first panel of the second tablet. As such, upon display, the one or more tablets' content placed upon the substrate remains undisturbed and preserved.

Certain embodiments of the present invention surround a system having tablets for mating with a magnetically attractable surface. The surface, having integrated magnets for alignment, provide confirmation of alignment of a tablet to the surface in a predetermined array configuration. Such magnets for alignment provide increased retention of tablets and provide a predetermined array configuration having a pleasing aesthetic.

In certain embodiments the invention comprises a magnetically attractable substrate having a dry erase surface. Alignment magnets are integrated into the substrate such that a first surface of the alignment magnet is consistent with the dry erase surface. Thus, upon placement of the one or more tablets upon the magnetically attractable surface, the one or more tablets is removably affixed to the dry erase surface. A user may slidably align a first magnetic insert with a first alignment magnet, thus resulting in increased fixation of the first magnetic insert to the substrate at the point of the first alignment magnet. Furthermore, a user may further slidably align a second magnetic insert with a second alignment magnet, thus resulting in increased fixation of the second magnetic insert to the substrate at the point of the second alignment magnet. Further still, the alignment of the second magnetic insert to the second alignment magnet may result in the alignment of all the magnetic inserts of a tablet aligning with corresponding alignment magnets, thus providing increased fixation of the tablet to the substrate and aligning the tablet to a predetermined array configuration. Furthermore, if necessary, the substrate having a dry erase surface, may be used as an additional erasable writing surface.

These and other advantages will be apparent from the disclosure of the inventions contained herein. The above-described embodiments, objectives, and configurations are neither complete nor exhaustive. As will be appreciated, other embodiments of the invention are possible using, alone or in combination, one or more of the features set forth above or described in detail below. Further, this Summary is neither intended nor should it be construed as being representative of the full extent and scope of the present invention. The present invention is set forth in various levels of detail in this Summary, as well as in the attached drawings and the detailed description below, and no limitation as to the scope of the present invention is intended to either the inclusion or non-inclusion of elements, components, etc. in this Summary. Additional aspects of the present invention will become more readily apparent from the detailed description, particularly when taken together with the drawings, and the claims provided herein.

### BRIEF DESCRIPTION OF THE DRAWINGS

FIG. 1—A perspective view of panels of certain embodiments

FIG. 2A—A perspective view of a tablet of certain embodiments

FIG. 2B—A side enlarged view of the connection of a first panel and a second panel of certain embodiments

FIG. 3A—A perspective view of an insert of certain embodiments

FIG. 3B—A cross-sectional view of an insert of certain embodiments

FIG. 4A—An enlarged view of a vertex of a panel of various embodiments

FIG. 4B—An enlarged view of a vertex of a panel of various embodiments

FIG. 4C—An enlarged view of a vertex of a panel of various embodiments

FIG. 4D—An enlarged view of a vertex of a panel of various embodiments

FIG. 5A—A perspective view of a first tablet and a second tablet of certain embodiments removably affixed in a stacked configuration

FIG. 5B—A side view of a first tablet and a second tablet of certain embodiments removably affixed stagger-stacked configuration

FIG. 6—A perspective view of a system of certain embodiments

### DETAILED DESCRIPTION OF VARIOUS EMBODIMENTS

As described below, embodiments of the present invention surround a tablet 1000 providing surfaces for erasable writing and configurations comprising mounting features, interconnection features, and/or other features. It is the applicant's intent that this specification and the claims appended here to be accorded a breadth in keeping with the scope and spirit of the invention being disclosed despite what might appear to be limiting language imposed by the requirements of referring to the specific examples disclosed.

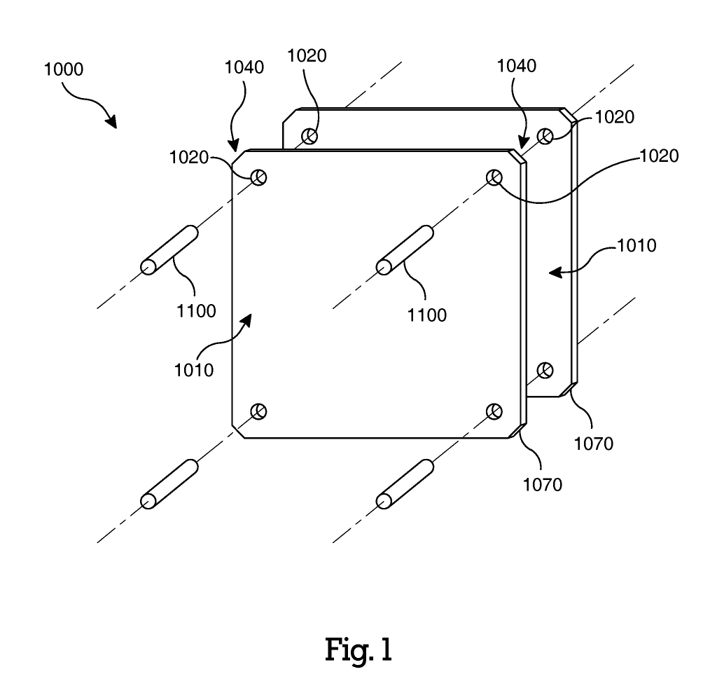

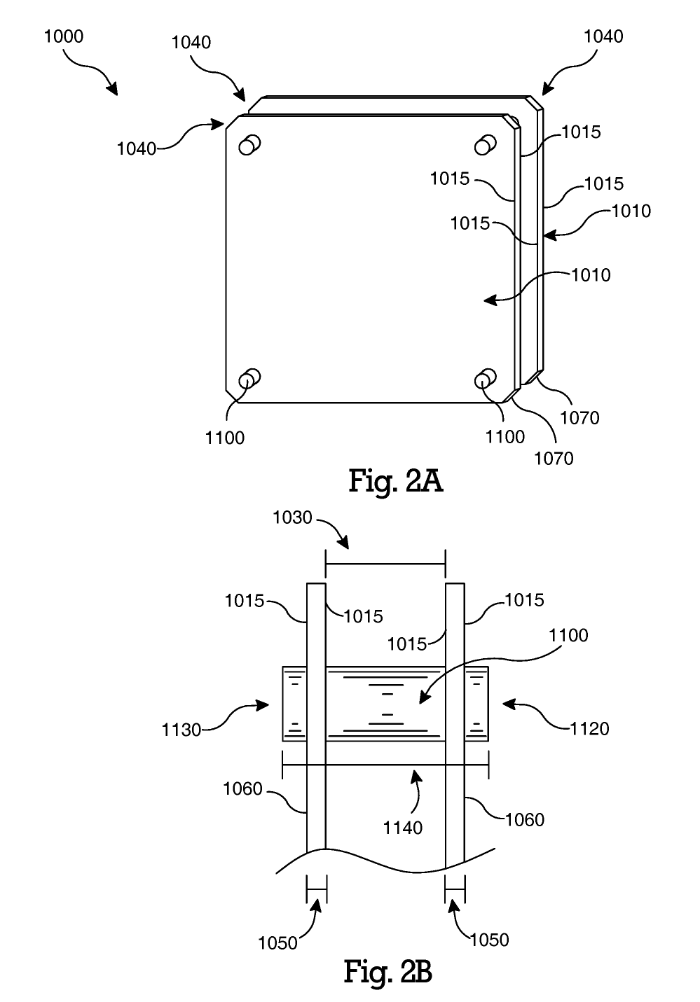

Certain embodiments of the present invention, shown in FIG. 1 and FIG. 2A, comprise a tablet 1000 comprising a first panel 1010 having a first aperture 1020, and a second panel 1010 having a first aperture 1020. When aligned, a first insert 1100, disposed through the first aperture 1020 of the first panel and the first aperture 1020 of the second panel constrains the first panel 1010 to the second panel 1010. In certain embodiments, such fixation of a first panel 1010 to a second panel 1010 further comprises an offset 1030 between the first panel 1010 and the second panel 1010. In certain embodiments, a first panel 1010 further comprises a second aperture 1020 and the second panel 1010 further comprises a second aperture 1020. A second insert 1100 disposed through the second aperture 1020 of the first panel and the second aperture 1020 of the second panel provides further constraint between the first panel 1010 and the second panel 1010.

A tablet 1000, shown in FIG. 1 and FIG. 2A, of certain embodiments comprises a first panel 1010 having a plurality of apertures 1020 and a second panel 1010 having a plurality of apertures 1020, wherein the plurality of apertures 1020 of the second panel are configured to align with the plurality of apertures 1020 of the first panel, and a plurality of inserts 1100 can be disposed through the aligned plurality of apertures 1020 to constrain the first panel 1010 with the second panel 1010 as shown in FIG. 2A.

A first panel 1010 of certain embodiments, shown in FIG. 1, comprises a material for treating with a surface treatment. Various embodiments comprise a first panel 1010 composed of various materials, for example, thermoplastic polyurethane (TPU), acrylic, polylactic acid (PLA), Acrylonitrile butadiene styrene (ABS), polyvinyl chloride (PVC), thermoplastics, polyethylene, or other polymers. It will be appreciated that a first panel 1010 may comprise a transparent, translucent, or opaque material in keeping with the scope and spirit of the invention.

A first panel 1010 of certain embodiments, shown in FIG. 1, comprises a magnetically attractable material. A magnetically attractable material of various embodiments include, but are not limited to, ferromagnetic materials including iron, nickel, cobalt and some alloys of rare-earth metals.

In certain embodiments, shown in FIG. 2A, a first aperture 1020 of a first panel is proximal to a first vertex 1040 of the first panel. Furthermore, in certain embodiments a second aperture 1020 of a first panel is proximal to a second vertex 1040 of the first panel. In certain embodiments, a first panel 1010 having a polygonal form has an aperture 1020 proximal to each vertex 1040 of the polygonal form of the first panel.

Certain embodiments of the present invention, shown in FIG. 1 and FIG. 2A, comprise a first panel 1010 having a plurality of apertures 1020, and a second panel 1010 comprising a plurality of apertures 1020, wherein the alignment of the plurality of apertures 1020 of the first panel with the plurality of apertures 1020 of the second panel allows for disposing an insert 1100 through each of the aligned plurality of apertures 1020, thus constraining the first panel 1010 to the second panel 1010. In certain embodiments, the first panel 1010 is constrained with an offset 1030 from the second panel 1010. In certain embodiments, the first panel 1010 is constrained parallel to the second panel 1010.

Certain embodiments of the present invention, shown in FIG. 1, comprise a first panel 1010 and a second panel 1010 having substantially similar size and shape. In certain embodiments, a first panel 1010 comprises a polygon. However, the embodiments of the present invention are not limited to comprising polygons, and may include other shapes such as circles. A panel 1010 of certain embodiments comprises a regular polygonal form. In certain embodiments, a panel 1010 comprises a square form.

In certain embodiments, a second aperture 1020, referencing FIG. 1, of a first panel is proximal to a second vertex 1040 of the first panel. In certain embodiments, a first panel 1010 having a polygonal form has an aperture 1020 proximal to each vertex 1040 of the polygonal form of the first panel.

Certain embodiments of the present invention surround a tablet 1000 (FIG. 2A) comprise a first panel 1010 and a second panel 1010. The first panel 1010 and the second panel 1010, each being substantially planar and having substantially similar form. The first panel 1010 and second panel 1010 are interconnected with an offset 1030 from each other.

In certain embodiments, as shown in FIG. 1, a first aperture 1020 of a first panel is proximal to a first vertex 1040 of the first panel.

Certain embodiments of the present invention, shown in FIG. 1A and FIG. 2B, comprise a tablet 1000 having a first panel 1010 and a second panel 1010 interconnected by a plurality of inserts 1100. The first panel 1010 comprises a first surface 1015 and a second surface 1015, each having a surface treatment. In certain embodiments, the second panel 1010 comprises a first surface 1015 and a second surface 1015, each having a surface treatment. A surface treatment, as directed to the present invention include a dry erase surface, a chalk board surface, a brick connection surface. However, the embodiments of the present invention are not limited to the above-mentioned surface treatments and may include other surface treatments in keeping with the scope and spirit of the present invention.

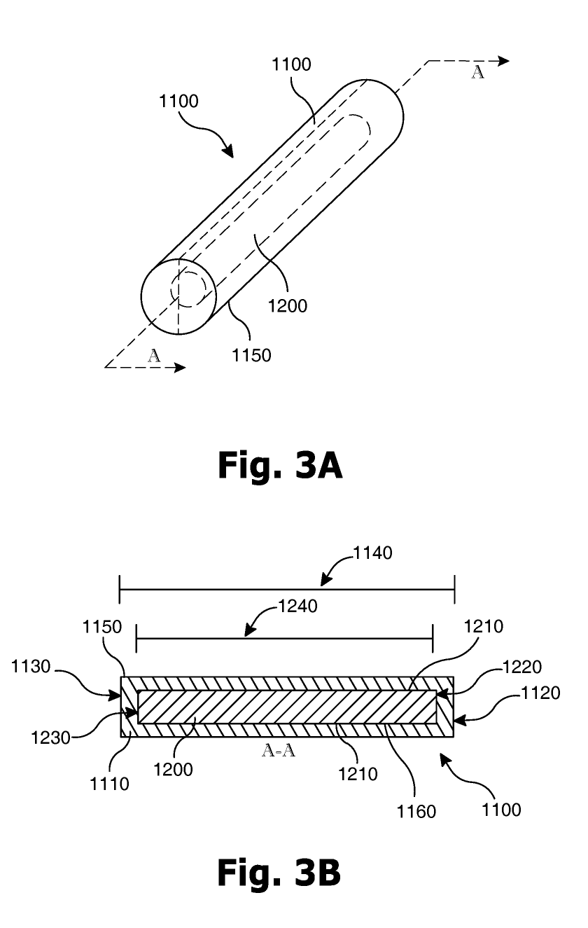

Inserts 1100 of certain embodiments of the present invention comprise a magnet 1200 (FIG. 3B) configured to be disposed through an aligned first aperture 1020 of a first panel and the second aperture 1020 of a second panel, referencing FIG. 1 and FIG. 2A. In certain embodiments, an insert 1100, shown in FIG. 3A and FIG. 3B, further comprises a sleeve 1110. A sleeve 1110, comprises an outer surface 1150 configured to mate with a first aperture 1020 of a first panel and a first aperture 1020 of a second panel (shown in FIG. 1), resulting in an engineering fit. An engineering fit will be appreciated to surround a location fit, press fit, interference fit, RC fit, or other engineering fit such as those specified by ANSI B4.1 (Standard Tolerance Limits and Fits), incorporated by reference herein. It will be further appreciated that other engineering fits or assembly strategies known to those skilled in the art may be used while in keeping with the scope and spirit of the present invention. A sleeve 1110, shown in FIG. 3A and FIG. 3B, of certain embodiments comprises an outer surface 1150 for mating with a first aperture 1020 (FIG. 1 and FIG. 2A) and an inner surface 1160 configured to constrain an outer surface 1210 of a magnet. Various embodiments comprise sleeves 1110 composed of various materials, for example, thermoplastic polyurethane (TPU), acrylic, polylactic acid (PLA), Acrylonitrile butadiene styrene (ABS), polyvinyl chloride (PVC), thermoplastics, polyethylene, or other polymers.

Certain embodiments, shown in FIG. 2B and FIG. 3B, comprise a sleeve 1110 having a length 1140 greater than the combination of a thickness 1050 of a first panel, a thickness 1050 of a second panel, and a desired offset 1030 between the first panel 1010 and the second panel 1010. Thus, the assembly of a first panel 1010 and a second panel 1010 using a sleeve 1110, shown in FIG. 2B, results in a first end 1120 of the sleeve extending beyond a first outer surface 1060 of a first panel and a second end 1130 of the sleeve beyond a first outer surface 1060 of the second panel. In certain embodiments, shown in FIG. 3B, a magnet 1200 has a length 1240 less than the length 1140 of the sleeve, and is disposed within the sleeve 1110. Thus, a first end 1220 of the magnet is recessed from the first end 1120 of the sleeve and a second end 1230 of the magnet is recessed from the second end 1130 of the sleeve.

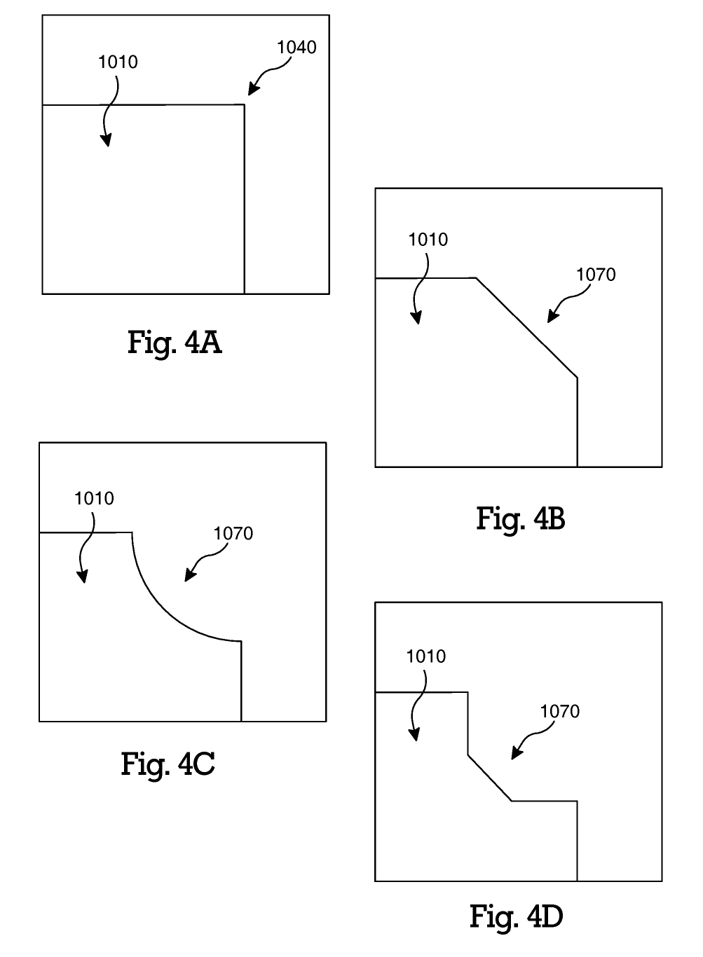

Certain embodiments of the present invention comprise a panel 1010 having notches 1070, as shown in FIG. 1 and FIG. 2A. A notch 1070 comprises a section of removed material in connection with the external perimeter of a panel. Certain embodiments comprise a first notch 1070 in a first panel, while other embodiments further comprise a second notch 1070 in a second panel configured to align with the first notch 1070 of the first panel. FIG. 4A demonstrates a panel vertex 1040 without a notch. A notch 1070, shown in FIG. 4B, comprises a linear cut between two adjacent sides of a polygon, resulting in a truncated vertex 1040. However, the embodiments of the present invention are not limited to notches 1070 having a linear cut, and may include radiused (FIG. 4C), polygonal (FIG. 4D), or other shaped notch 1070.

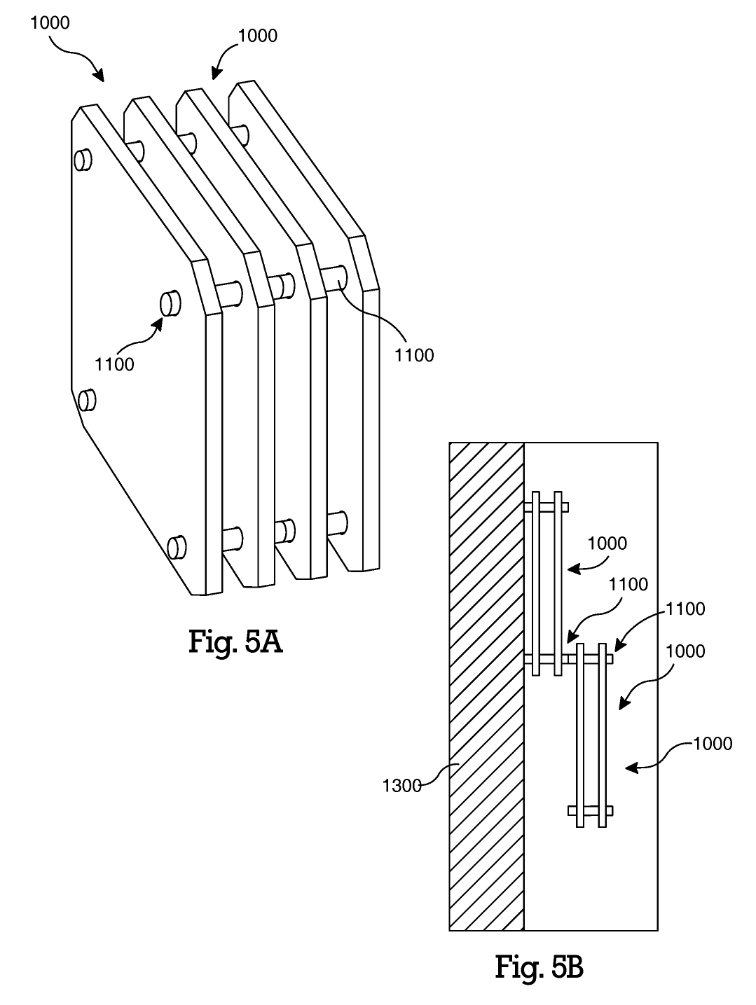

In certain embodiments, shown in FIG. 5A, a first tablet 1000 is removably affixed to a second tablet 1000. The second tablet 1000, having four inserts 1100 mated with four inserts 1100 of the first tablet, is removably affixed to the first tablet 1000 in a stacked configuration. In certain embodiments, the inserts 1100 of the first panel and the inserts 1100 of the second panel comprise magnets 1200. Thus, the alignment of the inserts 1100 of the first panel with the inserts 1100 of the second panel results in the removable fixation of the first panel 1000 to the second panel 1000.

In certain embodiments, shown in FIG. 5A and FIG. 5B, a first tablet 1000 is removably affixed to a substrate 1300 and a second tablet 1000 removably affixed to the first tablet 1000, shown in FIG. 5A and FIG. 5B. In certain embodiments, a first insert 1100 of the second tablet is mated with the first insert 1100 of the first tablet. In further embodiments, a second insert 1100 of the second tablet is mated with the second insert 1100 of the first tablet, thus affixing the second tablet 1000 to the first tablet 1000 in a stacked configuration (FIG. 5A) or a stagger-stacked configuration (FIG. 5B).

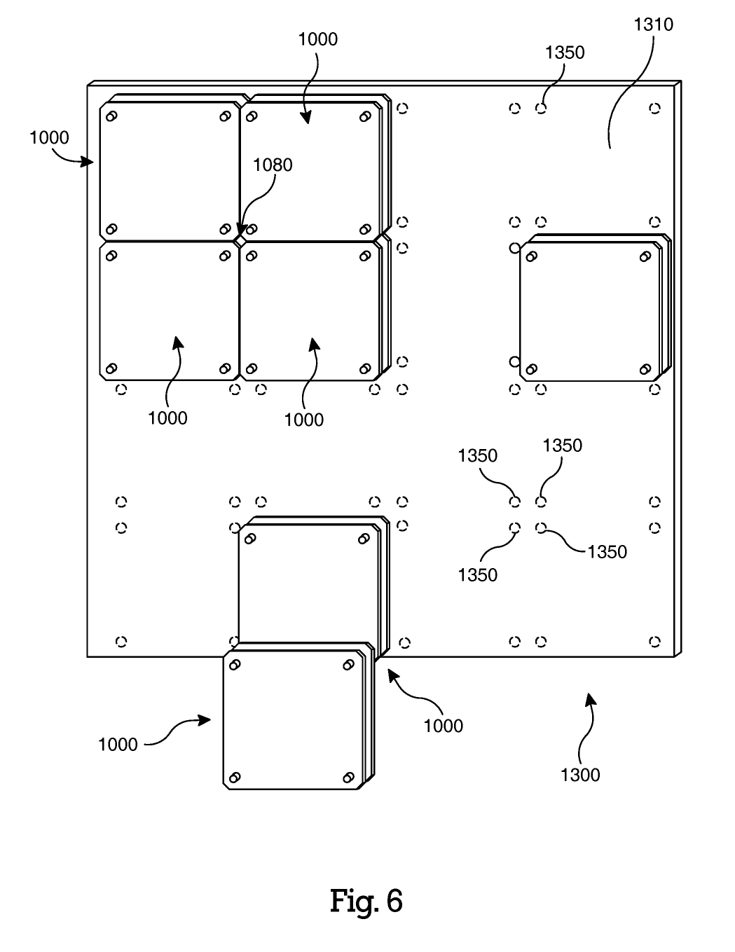

Certain embodiments of the present invention comprise a first tablet 1000, a second tablet 1000 and a first substrate 1300, shown in FIG. 5B and FIG. 6, having a magnetically attractable first surface 1310. In certain embodiments, the first surface 1310 comprises a dry erase surface.

In certain embodiments, shown in FIG. 6, a first alignment magnet 1350 combined with a first substrate 1300 having a magnetically attractable surface such that a first end 1360 of the first alignment magnet is consistent with or having an offset 1030 from the surface of the first substrate, thus providing an uninterrupted first surface 1310 of the substrate. An uninterrupted first surface 1310 of the substrate allows the unfettered slidable rearrangement of a tablet 1000 on the first surface 1310.

Certain embodiments of the present invention, shown in FIG. 6, comprise a first substrate 1300 further comprising a first alignment magnet 1350, while some embodiments comprise a first alignment magnet 1350 and a second alignment magnet 1350. In certain embodiments, a first surface 1310 comprises a plurality of alignment magnets 1350 in an array or matrix configuration which is configured to align with a first magnet 1200 and a second magnet 1200 of a tablet. In certain embodiments, once again referencing FIG. 6, a plurality of alignment magnets 1350 are configured in an array allowing the removable fixation of a plurality of tablets 1000 to the substrate such that a first tablet 1000 abuts a second tablet 1000.

Certain embodiments of the present invention, shown in FIG. 6, comprise a plurality of tablets 1000 removably affixed to a substrate 1300. Each tablet 1000, further comprise a first notch 1070, wherein the notch 1070 of adjacent abutting tablets 1000 interface, resulting in an opening 1080.

Certain embodiments of the present invention may be configured to mate with a substrate or surface of existing solutions in the prior art such as U.S. Patent Publication No. 2015/0099259 to Franco published Apr. 9, 2015, which discloses a tablet and system of tablets with interconnection features, which is hereby incorporated by reference in its entirety. It will be appreciated that such embodiments are in keeping with the scope and spirit of the present invention.

For purposes of further disclosure, the following references generally related to erasable writing tablets and/or interconnected tablets and are hereby incorporated by reference in their entireties:

U.S. Patent Publication No. 2013/0164730 to Gustafson published on Jun. 27, 2013, and discloses improved rewritable surfaces and methods for making the same;

U.S. Patent Publication No. 2009/0266721 to Bala published on Oct. 29, 2009, which discloses a school organization system including a panel, an opening between a clear window and the panel for inserting a document thereto, a writing surface with a magnetic re-writable writing surface or a flexible magnetic dry erase board, a permanent calendar, and a folder;

U.S. Patent Publication No. 2013/0224723 to Gonzales et al. published on Aug. 29, 2013, which discloses an erasable marker board assembly with a metal backing panel, a pre-printed poster and a transparent panel;

U.S. Patent Publication No. 2013/0224722 to Petak published on Aug. 29, 2013, which discloses a system for attaching at least one writing tablet to a surface configured to receive the writing tablet with a surface allowing a user to draw or write on the surface in a dry or wet erase manner, including a backing element and a tablet element, each having a surface with an array of touch fastening elements allowing the backing element and tablet element to be removably engageable to one another;

U.S. Patent Publication No. 2011/0128216 to Renwick discloses a retractable hinge;

U.S. Patent Publication No. 2013/0157246 to Shapiro published on Jun. 20, 2013, and discloses a removable dry erase board;

U.S. Patent Publication No. 2006/0214919 to Moore et al. discloses a multi-panel writing surface and visual display device with each panel having an erasable surface, and which may be mounted to a surface to display information;

U.S. Patent Publication No. 2006/0257198 to Roeloffs;

U.S. Pat. No. 7,170,468 to Knopf discloses male and female docking members to interconnect two or more devices;

U.S. Patent Publication No. 2012/0171656 to Shen discloses a mobile handwriting recording instrument for use in a lecture or classroom setting that includes a writing tablet, which has a writing surface, a transmitter, a receiver, and a scanning device for capturing two or three dimensional indicia placed within the scanning device's field of view displaying an image representing the handwritten indicia remotely;

U.S. Patent Publication No. 2006/0236572 to Ko discloses an ornamental writing board having the ornamental function of a picture and comprising a board surface, a roll-up curtain, a frame surrounding the roll-up curtain, a pair of scrolls, and lights;

U.S. Pat. No. 6,266,045 to Myerson et al. discloses a housing with a handle assembly;

U.S. Pat. No. 4,911,536 to Ditzik discloses an interactive electro-optic display device used in combination with a transparent graphics tablet device providing an electronic writing surface for an integrated display-tablet operation;

U.S. Patent Publication No. 2012/0275842 to Nagao;

U.S. Patent Publication No. 2012/0268399 to Cheng et al. discloses a dynamic, dual-display system coupled with a computing device to provide at least two display panels for single-user or multiple-user applications;

U.S. Patent Publication No. 2012/0038570 to Delaporte discloses a reconfigurable touch screen computing device with folding configurations and an alignment locking mechanism;

U.S. Pat. No. 8,295,037 to Buuck et al. discloses an electronic device, such as an electronic book reader device, configured with two panels connected via a hinge;

U.S. Pat. No. 8,452,600 to Fleizach, which discloses an assisted electronic reader;

U.S. Pat. No. 7,604,481 issued to Owen et al. on Oct. 20, 2009;

and U.S. Pat. No. 7,354,273 issued to Donelan on Apr. 8, 2008.

In U.S. Pat. No. 3,531,898 to Facemire, which is incorporated by reference herein in its entirety, a plurality of display boards is suspended for sliding along a track. In U.S. Pat. No. 3,914,890 to Behlen, Jr., which is incorporated by reference herein in its entirety, a plurality of display panels or signs are mountable within tracks formed in parallel upstanding side posts. In U.S. Pat. No. 4,716,693 to Webster, which is incorporated by reference herein in its entirety, the structure includes details of roller assemblies used for movably supporting a sign or panel along a track. In U.S. Pat. No. 6,139,331 to Owen, which is incorporated by reference herein in its entirety, a board base apparatus provided both storage and display of board panels using slots or tracks.

A display board system as disclosed by U.S. Pat. No. 6,647,652 to Seiber, which is incorporated by reference herein in its entirety, is directed toward a system for displaying a display board in a variety of ways.

The white board and white board display system of U.S. Pat. No. 7,604,481 to Owen, et al. (“Owen”), which is incorporated by reference herein in its entirety, discloses a writing board system including several white boards and a frame for mounting allowing vertical concatenation.

U.S. Pat. No. 9,809,049 to Franco, disclosing interconnection features and a system of multiple tablet assemblies removably interconnected to one another.

While various embodiments of the present invention have been described in detail, it is apparent that modifications and alterations of those embodiments will occur to those skilled in the art. However, it is to be expressly understood that such modifications and alterations are within the scope and spirit of the present invention. Further, the inventions described herein are capable of other embodiments and of being practiced or of being carried out in various ways. In addition, it is to be understood that the phraseology and terminology used herein is for the purposes of description and should not be regarded as limiting. The use of “including,” “comprising,” or “adding” and variations thereof herein are meant to encompass the items listed thereafter and equivalents thereof, as well as, additional items.

What is claimed is:

1. A modularly reconfigurable writing tablet comprising:
a first panel having a substantially rectangular form having four notches, and four apertures, each of the four apertures proximal to one of the four notches;
a second panel, the second panel having the substantially rectangular form, the second panel having a first surface facing a first surface of the first panel, four notches, and four apertures, each of the apertures of the second panel configured to align with the four apertures of the first panel;
the second panel constructed from a magnetically attractable material;
the first surface of the second panel having a surface treatment selected from the group consisting of a dry erase surface, a chalk board surface, and a brick connection surface;
a second surface of the second panel having a surface treatment selected from the group consisting of a dry erase surface, a chalk board surface, and a brick connection surface;
a first insert having a first end, a second end, and further comprising a sleeve and a magnet;
the sleeve having an external surface configured to mate with the first aperture of the first panel and the first aperture of the second panel, a length greater than the combination of a thickness of the first panel, the thickness of the second panel and an offset;
the magnet having an outer surface configured to mate with an inner surface of the sleeve, the magnet disposed within the sleeve, the magnet having a length less than the length of the sleeve and a first end of the magnet recessed from a first end of the sleeve and a second end of each of the magnet recessed from the second end of the sleeve;
a second insert having the limitations of the first insert;
a third insert having the limitations of the first insert; and
a fourth insert having the limitations of the first insert,
wherein the disposition of the inserts through the aligned apertures of the first panel and second panel results in the constraint of the first panel to the second panel with the offset therebetween, and the first end of the inserts extending beyond the first surface of the first panel and the second end of the inserts extend beyond the first surface of the second panel.

2. A modularly reconfigurable writing system comprising:
a first tablet having a first insert comprising a magnet, the first insert having a first end extending beyond a first surface of the tablet and a second end extending beyond a second surface of the tablet;
a second tablet having a first insert comprising a magnet, the first insert having a first end extending beyond a first surface of the tablet and a second end extending beyond a second surface of the table, the inserts of the second tablet configured to align with the inserts of the first tablet;
a magnetically attractable first substrate comprising a first surface having a dry erase surface treatment;
a first alignment magnet having a first end consistent with or offset from the first substrate, and the first alignment magnet configured to mate with the first insert of the first tablet; and
a second alignment magnet having a first end consistent with or offset from the first substrate, and the second alignment magnet configured to mate with the second insert of the first tablet, wherein the disposition of the first insert of the first tablet and the second insert of the first tablet in contact with the first surface results in removable fixation of the first tablet to the first surface, and
wherein the disposition of the first insert of the first tablet in proximity of the first alignment magnet and the second insert of the first tablet in proximity of the second alignment magnet results in increased removable fixation of the first tablet to the first surface, and
wherein the disposition of the first insert of the second tablet in contact with the first insert of the first tablet, and the second insert of the second tablet in contact with the second insert of the second tablet results in the removable fixation of the second tablet to the first tablet.
